(19) United States
(12) Patent Application Publication
(10) Pub. No.: US 2006/0198609 A1
(43) Pub. Date: Sep. 7, 2006

(54) Audio/video format reproduction apparatus providing superior usability, and audio/video format reproduction method and program therefor

(76) Inventors: Satoshi Ogata, Ichikawa-shi (JP); Nobuyuki Hisano, Saitama-shi (JP); Kaori Tajima, Yokohama-shi (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 11/354,979

(22) Filed: Feb. 16, 2006

(30) Foreign Application Priority Data
Feb. 17, 2005 (JP) P2005-040705
Sep. 27, 2005 (JP) P2005-280080

(51) Int. Cl. H04N 7/00

(52) U.S. Cl. 386/95

(57) ABSTRACT

For the reproduction of data recorded on an information recording medium using an audio/video format that includes a plurality of audio streams, arranged so they may be performed during the same period of time, and an audio menu by which user selection of these audio streams is enabled, the state wherein an arbitrary audio stream is being reproduced is shifted directly to an audio menu display state (S110), and when an audio stream selection is made by a user, reproduction is resumed beginning at the reproduction position extant immediately before the audio menu was displayed. Thus, even when an audio menu is not displayed, a user is permitted to directly designate an arbitrary audio stream.

### BACKGROUND OF THE INVENTION

1. Field of the Invention

The present invention relates to an audio/video format reproduction apparatus providing superior usability, and an audio/video format reproduction method and a program therefor.

2. Description of the Related Art

The present day development of high-performance and multi-functional home electrical appliances is a continuing, vital process. And when, as a result of some technological advance, new functions are added to products, the usability of the products is ordinarily improved. However, especially for older, less technologically adept users, the addition of new functions may also tend to complicate the operation of products (see, for example, “White Paper on the National Lifestyle in Heisei 6 For Enjoying the Society of Longevity”, by the Economic Planning Agency, Nov. 18, 1994 [searched on Sep. 25, 2004], Internet <URL:

http://wp.cao.go.jp/zenbun/seikatsu/wp-p194/wp-194-02202.ht m1>). But it is not just the older, less technological adept for whom using new functions presents some difficulties, most consumers prefer products for which operation is essentially intuitive, and as a result, “user-friendliness” has come to be identified as a new, added product value (see, for example, “Human Centered Design (HCD) Process in Product Planning Phase And Effects Obtained By Introducing HCD Process”, Business Machines Information System Industry Association Corporation, Technology Committee, and Human Centered Design Subcommittee, May, 2004 [searched Sep. 25, 2004], Internet <URL: http://www.jbmia.or.jp/˜tc/rep-hcd0405.pdf>).

A demand exists for a product, an audio/video apparatus, that provides superior usability when used, for example, for the reproduction of audio/video data recorded on information recording media, such as optical disks. When a plurality of audio streams that can be reproduced during the same period of time are present on an information recording medium, two conventional methods are available for the selection of one audio stream during the reproduction of a title domain.

The first method is one for performing title domain reproduction, root menu display, audio menu display, audio selection, root menu display and title domain reproduction, in the named order. The second method is a method based on an Audio Stream Change command.

A usage disadvantage affecting the operation of the first method is that procedures for which processing must be completed before returning to the title domain reproduction are complicated, and thus, for a user, superior usability is not attainable. A disadvantage of the second method is that, although a direct operation is provided, a selectable audio type cannot be visually identified, and that since, for an operation, the same button must be repeatedly depressed and the stream numbers can be changed only one by one.

### SUMMARY OF THE INVENTION

The objective of the present invention is to provide an audio/video format reproduction apparatus, with which superior usability is attainable and with which the selection of a stream can be intuitively performed, and an audio/video format reproduction method and a program therefor.

An audio/video format reproduction apparatus according to the present invention, which reproduces information, recorded on an information recording medium, having an audio/video format that includes a plurality of audio streams, arranged for reproduction during the same period of time, and an audio menu (a selection menu) a user employs to select audio streams, comprises:
a reading unit, for converting information included using an audio/video format into an electrical signal;
an audio/video reproduction unit, for demodulating audio/video information based on information read by the reading unit;
a management information storage unit, for storing management information, used for reproducing audio/video information based on information read by the reading unit, and audio/video data management information, used for controlling audio/video data to be reproduced;
a reproduced audio/video data controller, for controlling audio/video data to be reproduced;
an input unit, for transmitting entries by a user; and
a shifting unit, for directly shifting an arbitrary state to an audio menu display state. According to this arrangement, switching streams requires only the minimum effort.

Further, according to the invention, before shifting to the audio menu display state, the shifting unit stores information for a preceding reproduction position and a preceding reproduction state. According to this arrangement, without a complicated user operation being required, reproduction can be resumed at a reproduction position and in a reproduction state extant immediately before the audio menu was displayed.

According to the invention, when a navigation command to be executed is determined in the audio menu display state, the shifting unit inhibits the execution of other navigation commands, such as one entered using a button on the audio menu, the execution of which is likely to have been determined based on the assumption that the audio menu is displayed through a normal root. According to this arrangement, a preceding command is preferentially performed, and reproduction is appropriately resumed.

According to the invention, when a user selects an audio stream in the audio menu display state, the shifting unit employs the reproduction position information and the reproduction state and begins to reproduce the selected audio stream at a previously stored reproduction position. According to this arrangement, without a complicated user operation being required, reproduction can be resumed at a reproduction position and in a reproduction state extant immediately before the audio menu was displayed.

According to the invention, when the condition of an audio stream selected by a user is one for which reproduction is not enabled, the shifting unit waits until reproduction is enabled before beginning to reproduce the selected audio stream. According to this arrangement, without a complicated user operation being required, reproduction of an audio stream selected by a user can be resumed at an appropriate time.

Further, according to the invention, when the condition at the time an audio stream is selected by a user is not one whereunder reproduction is enabled, the shifting unit forcibly shifts the selected audio stream to a reproduction enabled state and starts reproduction. According to this arrangement, even when the state immediately before the audio menu is displayed is one wherein reproduction of a user selected audio stream is disabled, the audio stream can be reproduced at the time selected.

According to the invention, when only one audio stream is available when the state is shifted to the audio menu display state, the shifting unit provides a notification to that effect for a user and does not display the audio menu. According to this arrangement, an unnecessary operation, the display of the audio menu when user selection is impossible, can be prevented.

According to the invention, when an audio menu is not included in management information for shifting to the audio menu display state, the shifting unit provides a notification to that effect for a user. According to this arrangement, the user can readily ascertain that use of the audio menu, for audio stream selection, is disabled.

According to the invention, when am audio menu is not included in management information for shifting to the audio menu display state, the shifting unit shifts instead to a root menu display state. According to this arrangement, when a menu on which an audio stream can be selected is included as the root menu, the user can use that menu to select an audio stream.

Furthermore, an audio/video format reproduction apparatus according to the present invention, which reproduces information recorded, on an information recording medium, using an audio/video format that includes a plurality of audio streams arranged for reproduction during the same period of time, comprises:
a reading unit, for converting information included using an audio/video format into an electrical signal;
an audio/video reproduction unit, for demodulating audio/video information based on information read by the reading unit;
a management information storage unit, for storing management information, used for reproducing audio/video information based on information read by the reading unit, and audio/video data management information, used for controlling audio/video data to be reproduced;
a reproduced audio/video data controller, for controlling audio/video data to be reproduced;
an input unit, for transmitting an entry by a user; and
a switching unit, for changing, in an arbitrary state, to another audio stream. According to this arrangement, audio streams can be intuitively selected, and streams can be switched by performing an operation requiring minimal effort.

According to the invention, when there is only one audio stream to be changed, the switching unit provides a notification to that effect for a user and does not change audio streams. According to this arrangement, the user can readily ascertain that the selection of audio streams is disabled.

An audio/video format reproduction method according to the present invention, for reproducing information, recorded on an information recording medium, having an audio/video format that includes a plurality of audio streams, arranged for reproduction during the same period of time, and an audio menu (a selection menu) a user employs to select audio streams, comprises:
a shifting step of directly shifting an arbitrary state to an audio menu display state. According to this method, switching streams requires only the minimum effort.

Further, according to the invention, before shifting to the audio menu display state, information for a preceding reproduction position and a preceding reproduction state is stored at the shifting step. According to this method, without a complicated user operation being required, reproduction can be resumed at a reproduction position and in a reproduction state extant immediately before the audio menu was displayed.

According to the invention, when a navigation command to be executed is determined in the audio menu display state, the execution of other navigation commands, such as one entered using a button on the audio menu, the execution of which is likely to have been determined based on the assumption that the audio menu is displayed through a normal root, is inhibited at the shifting step. According to this method, a preceding command is preferentially performed, and reproduction is appropriately resumed.

According to the invention, when a user selects an audio stream in the audio menu display state, at the shifting step, reproduction of the selected audio stream is started at a previously stored reproduction position based on the reproduction position information and the reproduction state. According to this method, without a complicated user operation being required, reproduction can be resumed at a reproduction position and in a reproduction state extant immediately before the audio menu was displayed.

According to the invention, when the condition of an audio stream selected by a user is one for which reproduction is not enabled, at the shifting step, starting to reproduce the selected audio stream is waited until reproduction is enabled. According to this method, without a complicated user operation being required, reproduction of an audio stream selected by a user can be resumed at an appropriate time.

Further, according to the invention, when the condition at the time an audio stream is selected by a user is not one whereunder reproduction is enabled, at the shifting step, the selected audio stream is forcibly shifted to a reproduction enabled state and starts reproduction. According to this method, even when the state immediately before the audio menu is displayed is one wherein reproduction of a user selected audio stream is disabled, the audio stream can be reproduced at the time selected.

According to the invention, when only one audio stream is available when the state is shifted to the audio menu display state, at the shifting step, a notification to that effect is provided for a user and does not display the audio menu. According to this method, an unnecessary operation, the display of the audio menu when user selection is impossible, can be prevented.

According to the invention, when an audio menu is not included in management information for shifting to the audio menu display state, at the shifting step, a notification to that effect is provided for a user. According to this arrangement, the user can readily ascertain that use of the audio menu, for audio stream selection, is disabled.

According to the invention, when am audio menu is not included in management information for shifting to the audio menu display state, at the shifting step, shifting instead to a root menu display state is performed. According to this arrangement, when a menu on which an audio stream can be selected is included as the root menu, the user can use that menu to select an audio stream.

Furthermore, an audio/video format reproduction method according to the present invention, for reproducing information recorded, on an information recording medium, using an audio/video format that includes a plurality of audio streams arranged for reproduction during the same period of time, comprises:
a switching step of changing, in an arbitrary state, to another audio stream. According to this method, audio streams can be intuitively selected, and streams can be switched by performing an operation requiring minimal effort.

According to the invention, when there is only one audio stream to be changed, at the switching step, a notification to that effect is provided for a user and does not change audio streams. According to this method, the user can readily ascertain that the selection of audio streams is disabled.

A program according to the present invention, which permits a computer to perform the individual operations of an audio/video format reproduction apparatus that reproduces information, recorded on an information recording medium, having an audio/video format that includes a plurality of audio streams, arranged for reproduction during the same period of time, and an audio menu (a selection menu) a user employs to select audio streams, permits the computer to perform:
a shifting step of directly shifting an arbitrary state to an audio menu display state. According to this method, switching streams requires only the minimum effort.

Further, according to the invention, before shifting to the audio menu display state, information for a preceding reproduction position and a preceding reproduction state is stored at the shifting step. According to this method, without a complicated user operation being required, reproduction can be resumed at a reproduction position and in a reproduction state extant immediately before the audio menu was displayed.

According to the invention, when a navigation command to be executed is determined in the audio menu display state, the execution of other navigation commands, such as one entered using a button on the audio menu, the execution of which is likely to have been determined based on the assumption that the audio menu is displayed through a normal root, is inhibited at the shifting step. According to this method, a preceding command is preferentially performed, and reproduction is appropriately resumed.

According to the invention, when a user selects an audio stream in the audio menu display state, at the shifting step, reproduction of the selected audio stream is started at a previously stored reproduction position based on the reproduction position information and the reproduction state. According to this method, without a complicated user operation being required, reproduction can be resumed at a reproduction position and in a reproduction state extant immediately before the audio menu was displayed.

According to the invention, when the condition of an audio stream selected by a user is one for which reproduction is not enabled, at the shifting step, starting to reproduce the selected audio stream is waited until reproduction is enabled. According to this method, without a complicated user operation being required, reproduction of an audio stream selected by a user can be resumed at an appropriate time.

Further, according to the invention, when the condition at the time an audio stream is selected by a user is not one whereunder reproduction is enabled, at the shifting step, the selected audio stream is forcibly shifted to a reproduction enabled state and starts reproduction. According to this method, even when the state immediately before the audio menu is displayed is one wherein reproduction of a user selected audio stream is disabled, the audio stream can be reproduced at the time selected.

According to the invention, when only one audio stream is available when the state is shifted to the audio menu display state, at the shifting step, a notification to that effect is provided for a user and does not display the audio menu. According to this method, an unnecessary operation, the display of the audio menu when user selection is impossible, can be prevented.

According to the invention, when an audio menu is not included in management information for shifting to the audio menu display state, at the shifting step, a notification to that effect is provided for a user. According to this arrangement, the user can readily ascertain that use of the audio menu, for audio stream selection, is disabled.

According to the invention, when an audio menu is not included in management information for shifting to the audio menu display state, at the shifting step, shifting instead to a root menu display state is performed. According to this arrangement, when a menu on which an audio stream can be selected is included as the root menu, the user can use that menu to select an audio stream.

Furthermore, a program according to the present invention, which permits a computer to perform the individual operations of an audio/video format reproduction apparatus that reproduces information recorded, on an information recording medium, using an audio/video format that includes a plurality of audio streams arranged for reproduction during the same period of time, permits the computer to perform:
a switching step of changing, in an arbitrary state, to another audio stream. According to this method, audio streams can be intuitively selected, and streams can be switched by performing an operation requiring minimal effort.

According to the invention, when there is only one audio stream to be changed, at the switching step, a notification to that effect is provided for a user and does not change audio streams. According to this method, the user can readily ascertain that the selection of audio streams is disabled.

According to the invention, during the reproduction of an information recording medium on which information has been recorded using an audio/video format that includes a plurality of streams arranged for production during the same period of time, selection of streams can be intuitively understood, and streams can be changed by performing an operation requiring minimal effort.

### BRIEF DESCRIPTION OF THE DRAWINGS

FIG. 1 is a block diagram for explaining an overview of the user operation performed to change a stream in a DVD-Video disk reproduction apparatus according to the present invention.

FIG. 2 is a diagram showing the external appearance of a remote controller employed as an example input unit.

FIG. 3 is a block diagram showing the configuration of the DVD-Video disk reproduction apparatus according to the invention.

FIG. 4 is a schematic diagram showing the data structure of management information used to reproduce audio/video data recorded using an audio/video format.

FIG. 5 is a schematic diagram showing the data structure of VTSM_LU_SRP.

FIG. 6 is a schematic diagram showing the data structure of VTSM_PGCI_SRP.

FIG. 7 is a schematic diagram showing the data structure of management information used to reproduce audio/video data recorded using the audio/video format.

FIG. 8 is a schematic diagram showing the data structure of VTS_AST_Ns.

FIG. 9 is a schematic diagram showing the data structure. of VTS_AST_ATRT.

FIG. 10 is a schematic diagram showing the structure of a system parameter that is one of the navigation parameters for controlling the DVD-Video disk reproduction apparatus.

FIG. 11 is a flowchart showing the audio stream changing processing performed by a DVD-Video disk reproduction apparatus according to a first embodiment of the invention.

FIG. 12 is a flowchart showing the audio menu reproduction processing performed by a DVD-Video disk reproduction apparatus according to a second embodiment of the invention.

FIG. 13 is a flowchart showing the processing performed when the state stored in a management information storage unit does not indicate a title domain and is currently reproduced during the changing of an audio stream.

FIGS. 14A and 14B are flowcharts showing other processes performed when the state stored in a management information storage unit does not indicate a title domain and is currently reproduced during the changing of an audio stream.

FIG. 15 is a flowchart showing the processing performed when an audio menu display request is issued when only one audio stream is present.

FIG. 16 is a flowchart showing the processing performed when an audio menu display request is issued and an audio stream is not present.

FIG. 17 is a flowchart showing other processing performed when an audio menu display request is issued and an audio stream is not present.

FIG. 18 is a flowchart showing the audio stream change processing performed by a DVD-Video disk reproduction apparatus, according to a seventh embodiment of the invention, when an audio stream is designated.

FIG. 19 is a diagram showing an example screen used for a user notification.

### DESCRIPTION OF THE PREFERRED EMBODIMENTS

An audio/video format reproduction apparatus according to the present invention will now be described in detail while referring to the accompanying drawings. In the following explanation, a DVD-Video disk reproduction apparatus is employed as an example audio/video format reproduction apparatus.

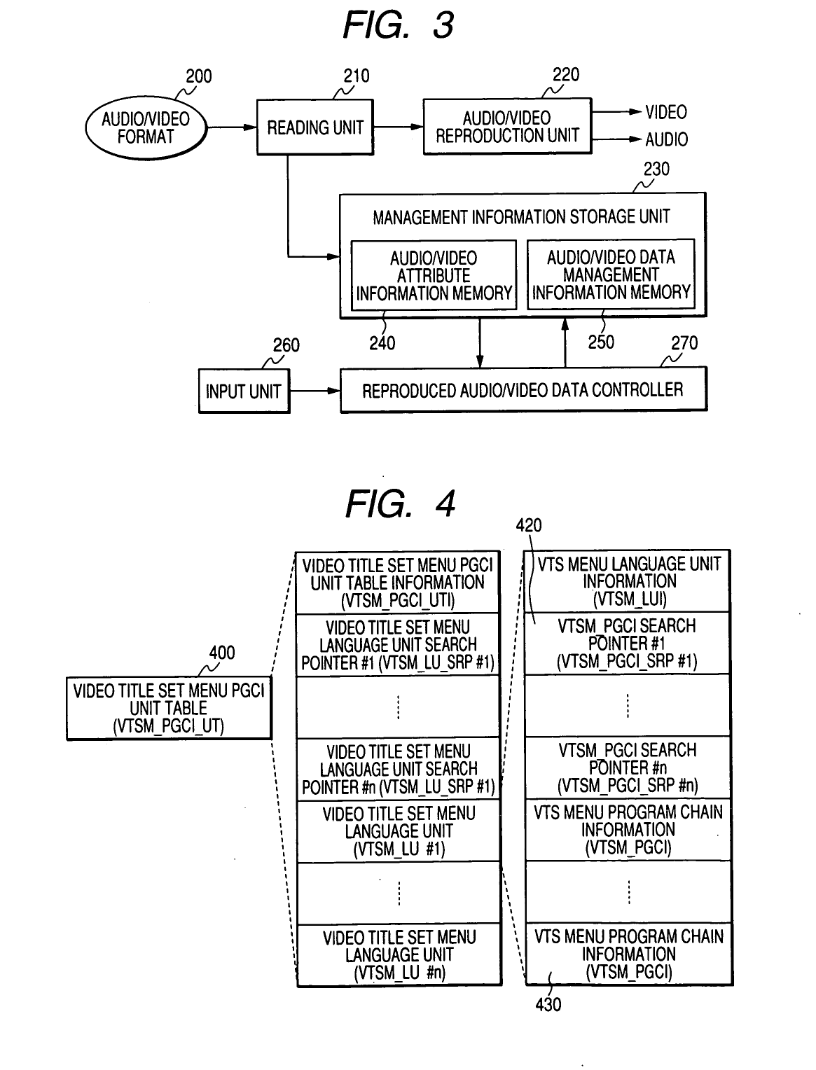

FIG. 3 is a block diagram showing the arrangement of a DVD-Video disk reproduction apparatus according to the invention.

The DVD-Video disk reproduction apparatus mainly comprises: a reading unit 210, for converting into an electrical signal information using an audio/video format 200; an audio/video reproduction unit 220, for demodulating audio/video information based on information included in the audio/video format 200 read by the reading unit 210; a management information storage unit 230, for storing management information to reproduce audio/video information based on information in the audio/video format 200 that is read by the reading unit 210; reproduced audio/video data controller 270, for controlling audio/video data to be reproduced; and an input unit 260, for transmitting entries made by a user.

The management information storage unit 230 includes an audio/video attribute information memory 240, used for storing management information employed for reproducing audio/video information recorded in the audio/video format 200; and an audio/video data management information memory 250, used for controlling audio/video data to be reproduced.

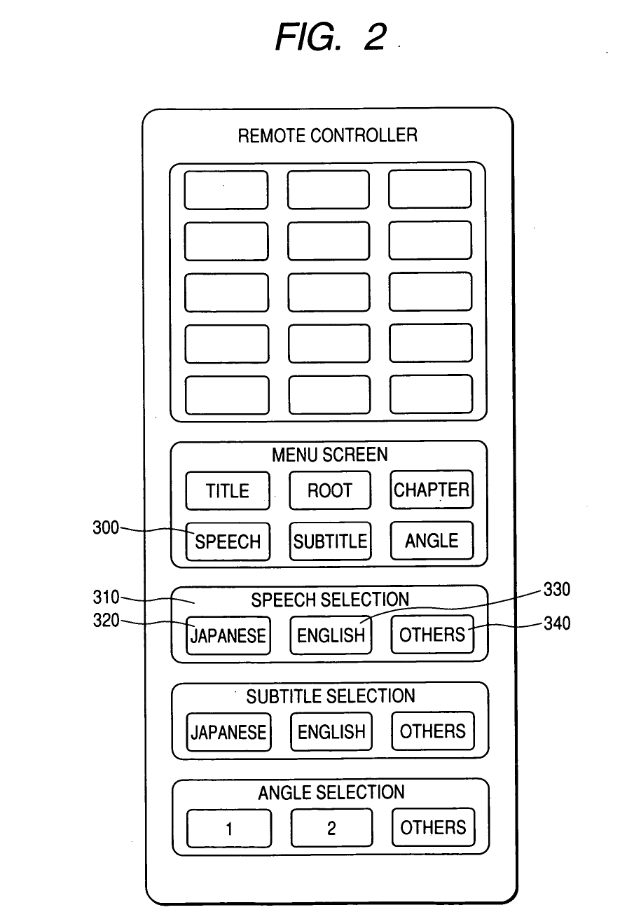

FIG. 2 is a diagram showing the external appearance of a remote controller that is an example input unit 260. The remote controller includes: a menu screen area for displaying screens of menus, such as an audio (speech) menu, a sub-picture (subtitle) menu and an angle menu, a speech selection area for selecting speech, a subtitle selection area for selecting subtitles, and an angle selection area for selecting angles.

When a speech menu key 300 on the menu screen area is depressed, the speech menu is displayed. Further, when a Japanese key 320, an English key 330, or another audio stream selection key 340 is depressed in a speech selection area 310 for selecting an audio (speech) stream, a corresponding speech stream, i.e., speech in a corresponding language, can be directly selected.

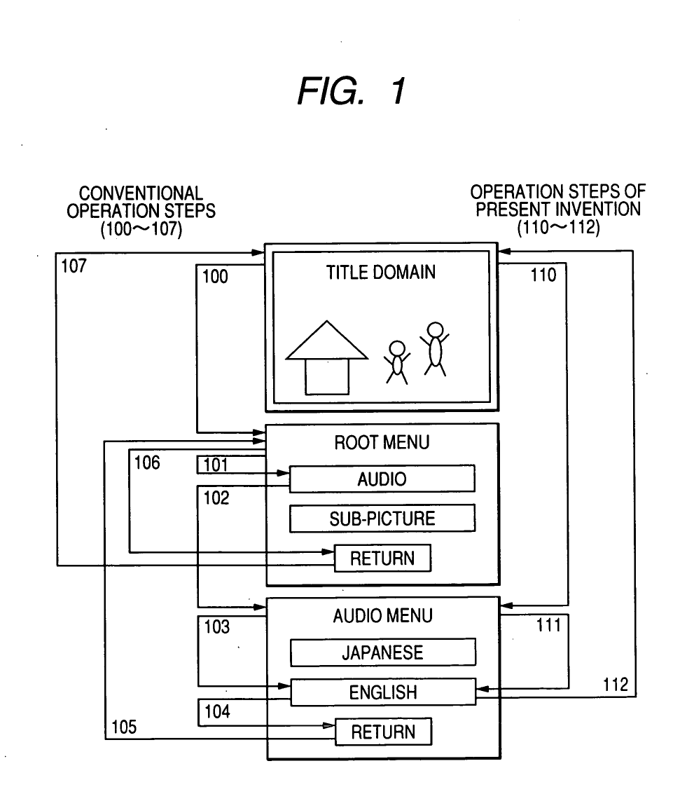

An overview of the operation of the DVD-Video disk reproduction apparatus having the above described arrangement will now be described by performing a comparison with the conventional case. FIG. 1 is a diagram for explaining the overview of the user operation for changing streams in the DVD-Video disk reproduction apparatus according to the present invention. In FIG. 1, for comparison, the conventional user operation is also shown.

For example, in order to change an audio stream to English, the DVD-Video disk reproduction apparatus of the invention shifts directly to the audio menu during reproduction of the title domain (step S110), and selects the English audio stream button (step S111). When the audio stream is simultaneously determined, reproduction of the title domain is resumed (step S112). Changing the audio stream is completed by employing this three-step user operation.

The conventional DVD-Video disk reproduction apparatus first shifts reproduction of the title domain to the root menu (step S100), selects the audio menu button (step S101), selects an audio menu display (step S102), and selects the English audio stream button (step S103). Then, the audio stream is determined (step S104), the current state is shifted to the root menu (step S105), the button for returning to the reproduction of the title domain is selected (step S106), and finally, resumption of the reproduction of the title domain is determined (step S107). These eight user operation steps are required.

As described above, according to the DVD-Video disk reproduction apparatus of the invention, since buttons for selecting audio streams and picture streams are separately provided for the remote controller, the types of streams can be intuitively identified, and the changing of streams can be performed by performing operations requiring minimal effort.

An explanation will be given for the data structure of audio/video data recorded using an audio/video format to be reproduced by the DVD-Video disk reproduction apparatus.

FIG. 4 is a diagram showing an example data structure for management information used to reproduce audio/video data recorded using an audio/video format. The management information includes: VTSM_PGCI_UT 400, in which a table is recorded wherein information is entered that is related to VTS menu program chain information used to reproduce video title set menus (VTSM) for individual languages; VTSM_LU_SRP 410, in which a search pointer for a VTSM language unit is recorded; VTSM_PGCI_SRP 420, in which a search pointer for VTSM program chain information is recorded; and VTSM_PGCI 430, in which VTSM program chain information is recorded.

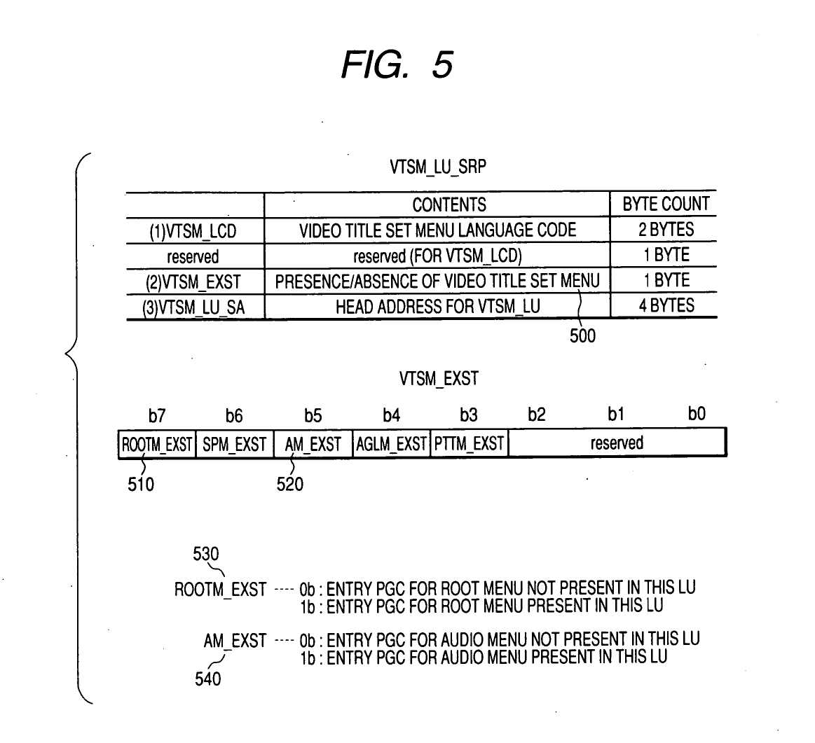

FIG. 5 is a schematic diagram showing the data structure of VTSM_LU_SRP 410. VTSM_LU_SRP 410 includes: VTSM_EXST 500, in which the presence/absence of a video title set menu is recorded; ROOTM_EXST 510, which is one of the detailed content listings for VTSM_EXST 500 and in which the presence/absence of a root menu is recorded; AM_EXST 520, in which the presence/absence of an audio menu is recorded; a definition 530 for ROOTM_EXST 510; and a definition 540 for AM_EXST 520.

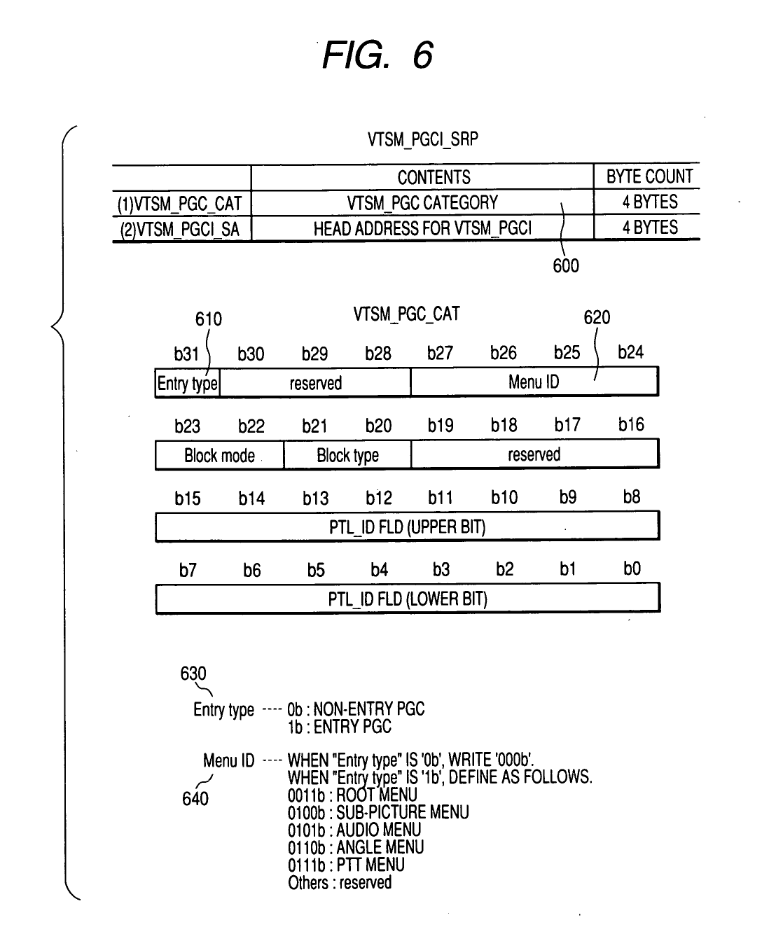

FIG. 6 is a schematic diagram showing the data structure of VTSM_PGCI_SRP 420. VTSM_PGCI_SRP 420 includes: VTSM_PGC_CAT 600, in which the category of PGC is recorded; an Entry type 610, which is one of the detailed content listings for VTSM_PGC_CAT 600 and in which whether an entry type is an entry PGC is recorded; a Menu ID 620, which is one of the detailed content listings for VTSM_PGC_CAT 600 and in which a menu type is recorded; a definition 630 for the Entry type 610; and a definition 640 for the Menu ID 620.

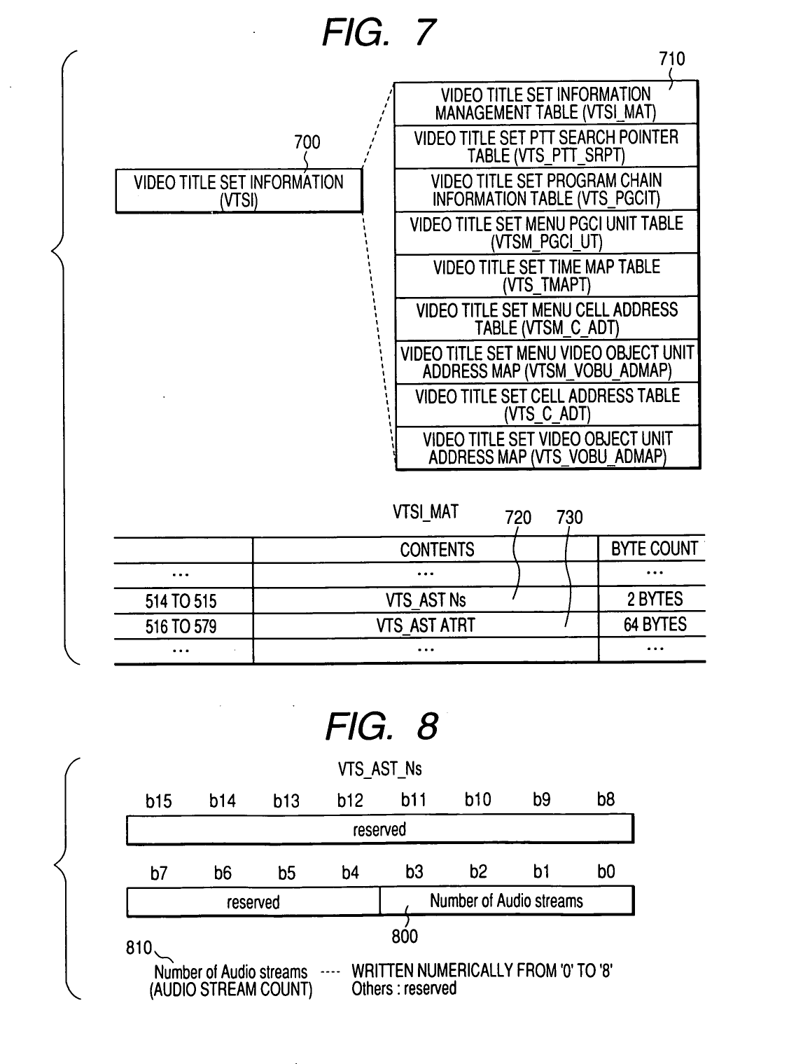

FIG. 7 is a schematic diagram showing the data structure of management information used to reproduce audio/video data recorded using the audio/video format. The management information includes: VTSI 700, in which information for one or more video titles and a VTS menu is recorded; VTSI_VAT 710, in which the head addresses for information recorded in the VTSI 700 and tables related to attributes of VOBS in the VTS are recorded; VTS_AST_Ns 720, which is one of the detailed content listings for VTSI_MAT 710 and in which the number of audio streams in VTSTT_VOBS for VTS is recorded; and VTS_AST_ATRT 730, which is one of the detailed content listings for VTSI_MAT 710 and in which the attributes of the individual audio streams in VTSTT_VOBS for VTS are recorded.

FIG. 8 is a schematic diagram showing the data structure of VTS_AST_Ns 720. VTS_AST_Ns 720 includes: Number of Audio streams 800, in which the number of audio streams in VTSTT_VOBS for VTS is recorded; and a definition 810 for Number of Audio streams 800.

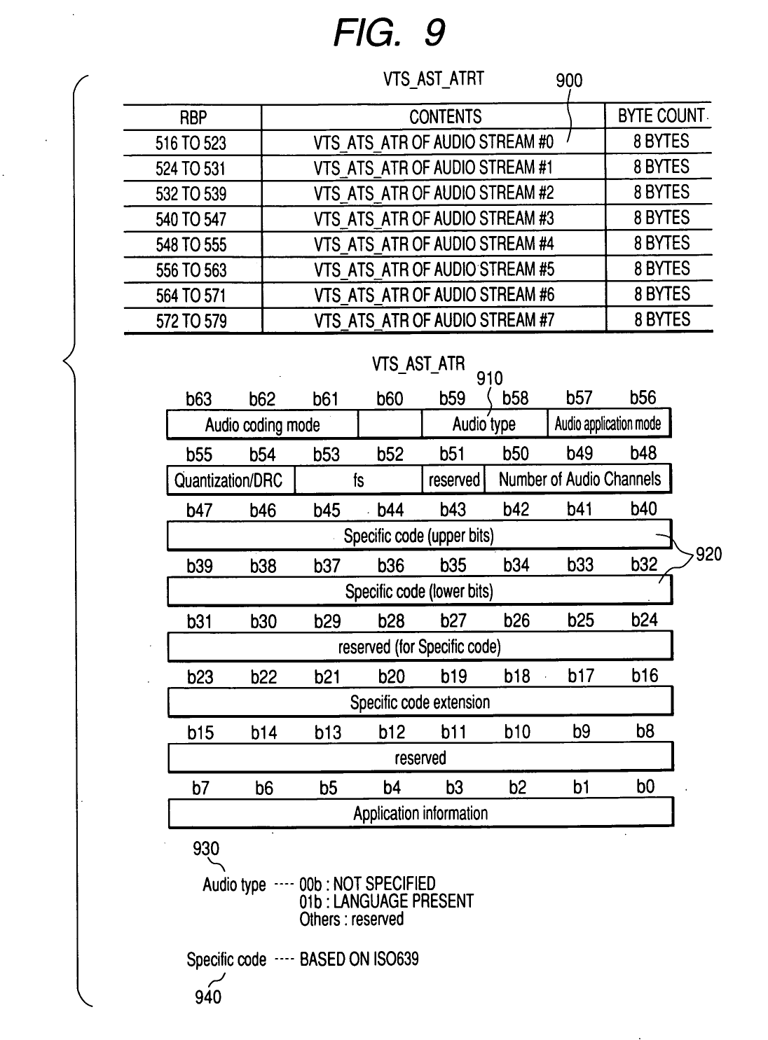

FIG. 9 is a schematic diagram showing the data structure of VTS_AST_ATRT 730. VTS_AST_ATRT 730 includes: VTS_AST_ATR 900, in which the attribute of a specific audio stream in VTSTT_VOBS for VTS is recorded; an Audio type 910, which is one of the detailed content listings for VTS_AST_ATR 900 and in which the presence/absence of a language for the pertinent audio stream is recorded; Specific code 920, which is one of the detailed content listings for VTS_AST_ATR 900 and in which a specific code for the pertinent audio stream is recorded; a definition 930 of the Audio type 910; and a definition 940 of the Specific code 920.

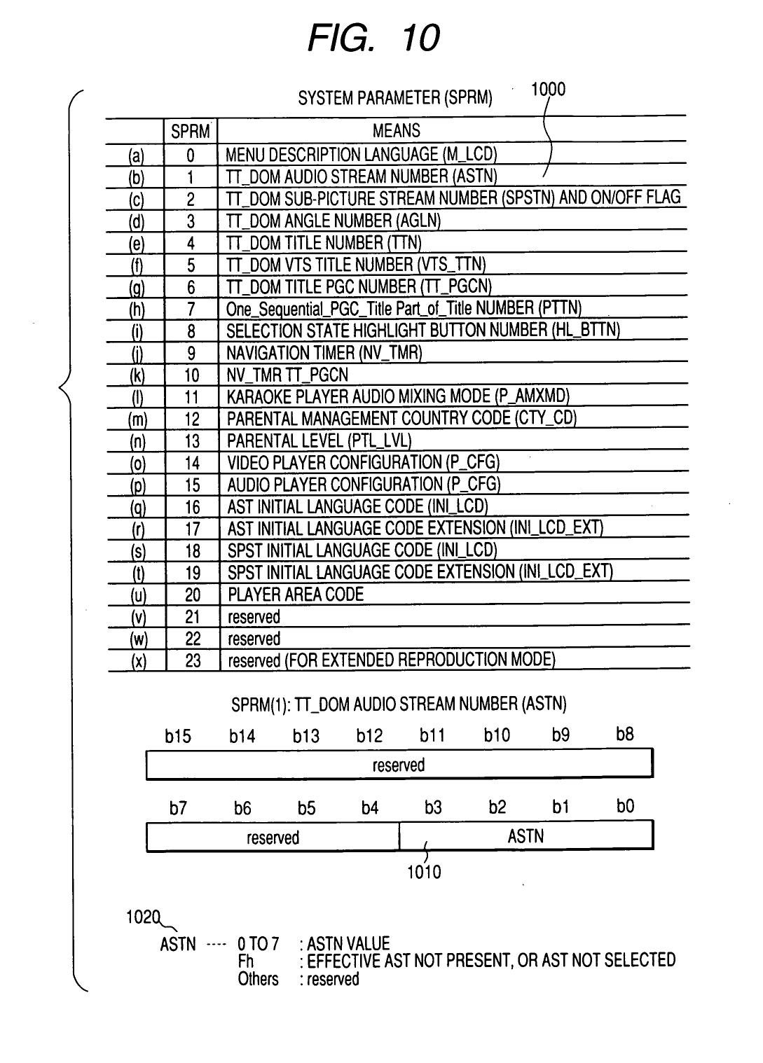

FIG. 10 is a schematic diagram showing the structure of a system parameter that is one of the navigation parameters for controlling the audio/video reproduction apparatus. The system parameter includes: SPRM[1] 1000, in which an audio stream number for a title domain is stored; ASTN 1010, which is one of the detailed content listings for SPRM[1] 1000 and in which an audio stream number for a title domain is stored; and a definition 1020 for ASTN 1010.

The switching operation performed by the thus arranged DVD-Video reproduction apparatus will now be described in detail. In the following explanation, an audio stream switching operation is employed as an example. Further, in the flowcharts used for the individual embodiments, the same step numbers are employed for corresponding processes, and no further explanation for them will be given.

### First Embodiment

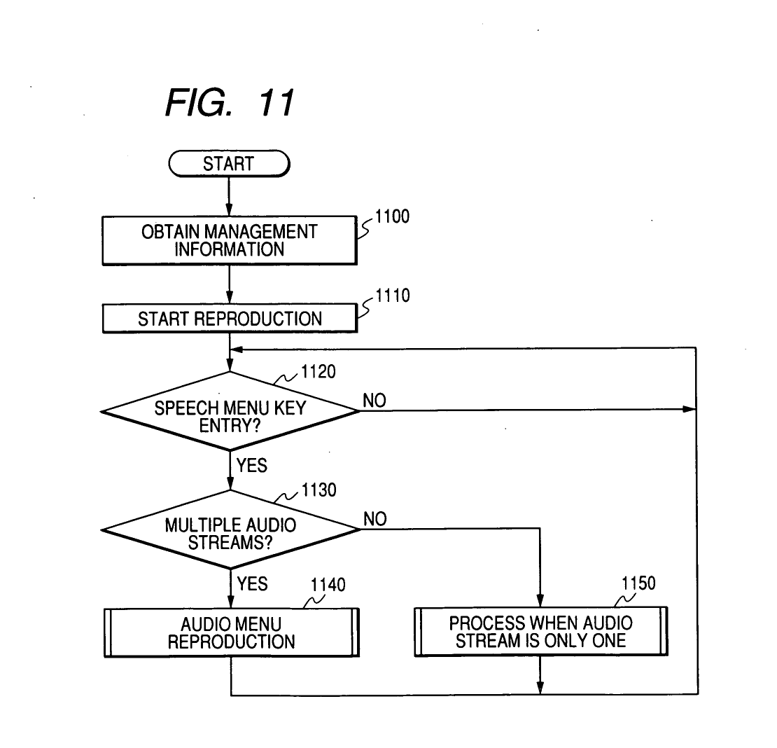

FIG. 11 is a flowchart showing the audio stream switching operation performed by a DVD-Video disk reproduction apparatus according to a first embodiment of the invention.

First, when reproduction is initiated for the audio/video format 200, management information recorded using the audio/video format 200 is read by the reading unit 210 and stored in the audio/video attribute information memory 240 and the audio/video data management information memory 250 in the management information storage unit 230 (step S1100). Then, audio/video data are transferred from the reading unit 210 to the audio/video reproduction unit 220, which begins the reproduction of the audio/video data (step S1110).

After the reproduction of the audio/video data has begun, the reproduced audio/video data controller 270 determines whether a user entry, made by manipulating the speech menu key 300 of the remote controller, has been received (step S1120). When an entry has been received, the audio stream count VTS_AST_Ns 720, which is stored at step S1100, is examined to determine whether there is a plurality of audio streams (step S1130). When there is a plurality of audio streams, the audio menu reproduction process is performed (step S1140). When there is only one audio stream, a user notification process, which will be described in detail later, is performed (step S1150).

The audio menu reproduction process (step S1140) will now be described. FIG. 12 is a flowchart showing the audio menu reproduction processing performed by the DVD-Video disk reproduction apparatus according to the first embodiment. First, the AM_EXST 520 stored at step S1100 is examined to determine whether the audio menu is present (step S1200). When the audio menu is not present, a user notification process, which will be described in detail later, is performed (step S1290).

When the audio menu is present, the reproduction position information and the reproduction state immediately before the audio menu is shifted are stored in the audio/video data management information memory 250 (step S1210). Then, the state is shifted to an audio menu display state (step S1220), and thereafter, a check is performed to determine whether, as a result of user manipulation, an entry for an audio stream selection has been received (step S1230). When such an entry has been received, a button command, one of the navigation commands, is executed (step S1240). Further, when the navigation command to be executed has been determined (step S1221), the execution is inhibited of other navigation commands (S1222), such as the button command on the audio menu, the execution of which would likely to be performed on the assumption that the audio menu is displayed through the normal root, such as the operation steps 100 to 103 in FIG. 1 (step S1223). For example, when GPRM is employed as a button command, the execution of this button command is inhibited. At this time, the user may be notified that the execution of navigation commands has been inhibited.

Following this, a check is performed to determine whether SPRM[1] 1000 has been changed by the execution of the button command (step S1250). When SPRM[1] 1000 has been changed, the execution of the button command is halted if the operation it performs has not yet been completed. Program control then advances to step S1260.

The reproduced audio/video data controller 270 determines whether reproduction position information stored at step S1210 indicates a position inside the title domain, and the state stored at step S1210 indicates a currently reproducing state (step S1260). When both conditions are satisfied, reproduction is resumed beginning at the reproduction position and in the reproduction state stored at step S1210 (step S1270).

When the reproduction position information stored at step S1210 indicates a position other than one inside the title domain, or when the reproduction information stored at step S1210 indicates a position inside the title domain but the reproduction state indicates a state other than the currently reproducing state, a process such as a waiting process, which will be described in detail later, is performed (step S1280).

As described above, according to the DVD-Video disk reproduction apparatus of the first embodiment, a speech menu key is provided for the remote controller, and the audio menu is displayed directly, under the control of the reproduced audio/video data controller 270, i.e., the shifting means is constituted by the speech menu key and the reproduced audio/video data controller. Thus, switching between streams requires the performance of the minimum number of operations. Furthermore, since the reproduction position information and the reproduction state immediately before the stream was changed are stored in the management information storage unit 230, reproduction can be resumed, without a complicated user operation being required, beginning at the reproduction position and in the reproduction state extant immediately before the audio menu was displayed.

In this embodiment, the speech menu key 400 of the remote controller is employed as the shifting unit for shifting the display to the audio menu (step S1120 in the flowchart in FIG. 11). However, shifting to the audio menu may be performed by an entry received upon the depression of a specific key other than the speech menu key 300, following the long depression of a specific key on the remote controller, or via a user interface other than the remote controller.

### Second Embodiment

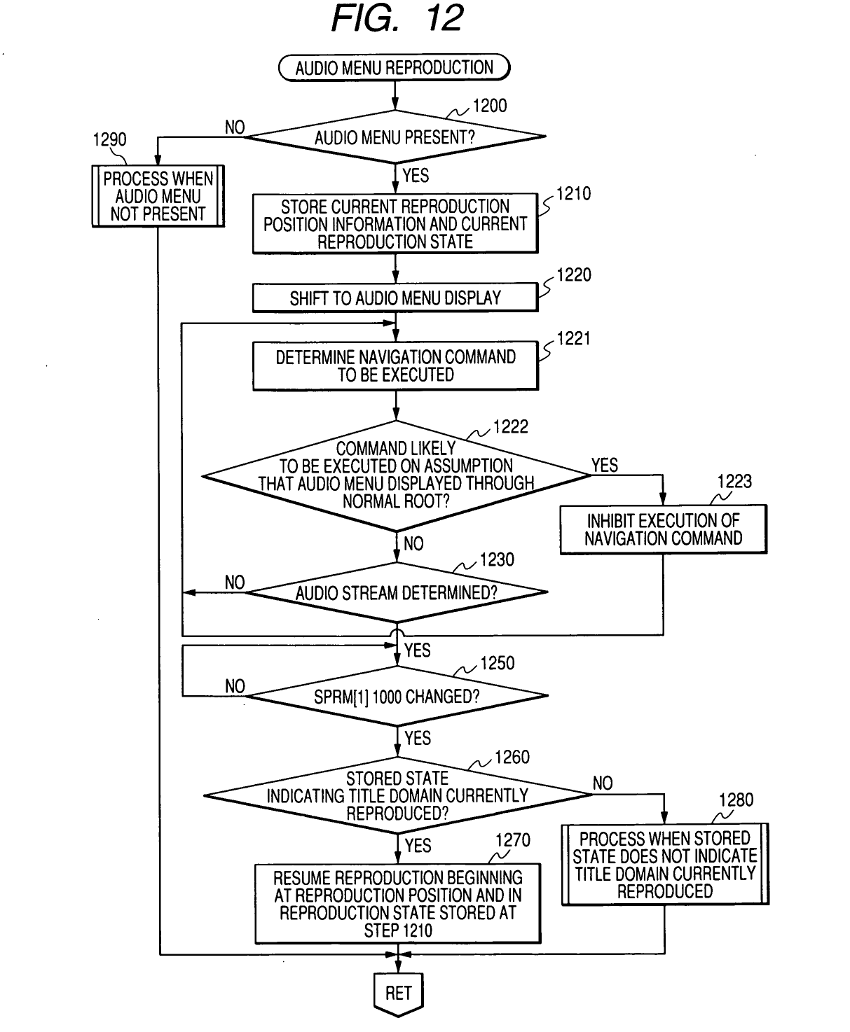

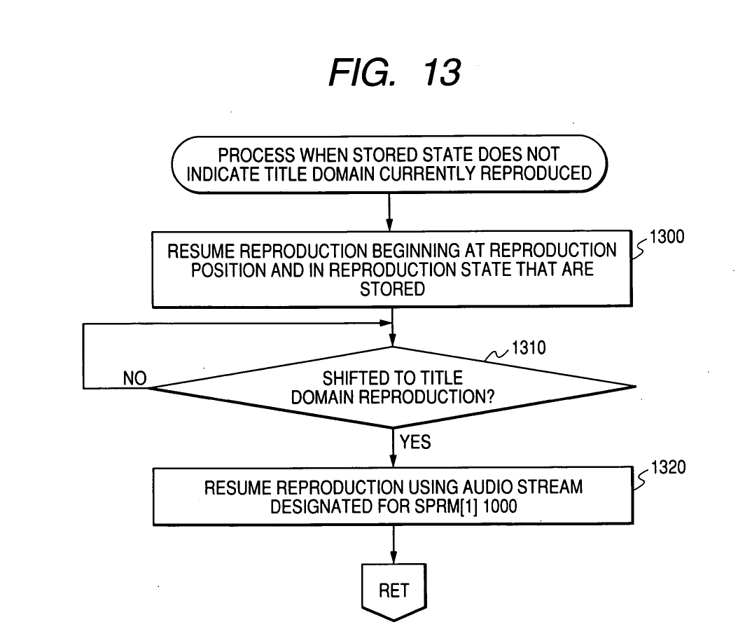

FIG. 13 is a flowchart showing the processing (step S1280 in the flowchart in FIG. 12) when the state stored in the management information storage unit 230 during the changing of an audio stream does not indicate that a title domain is currently being reproduced. This processing is performed when the stored reproduction position information indicates other than a title domain, or when the stored reproduction position information indicates a position inside a title domain and the reproduction state is not a currently reproducing state.

First, the reproduction position and the reproduction state stored in the management information storage unit 230 are restored (step S1300). This state can, for example, be a title menu display state, a root menu display state, or a temporary halted state in a title domain. Thereafter, the reproduced audio/video data controller 270 determines whether the state has been shifted to the title domain reproduction state by user manipulation or by the execution of a navigation command (step S1310). When the state has been shifted to the title domain reproduction state, the SPRM[1] 1000 value changed at step S1240 becomes effective, and the reproduced audio/video data controller 270 begins the reproduction of an audio stream selected through user manipulation at step S1230 (step S1320).

As described above, according to the DVD-Video disk reproduction apparatus of the second embodiment, during the changing of the audio stream, the reproduced audio/video data controller 270 determines whether the current state is the title domain reproduction state, and reproduces a selected audio stream when reproduction is enabled. Thus, without a complicated user operation being required, reproduction of an audio stream selected by a user can be resumed at an appropriate time.

### Third Embodiment

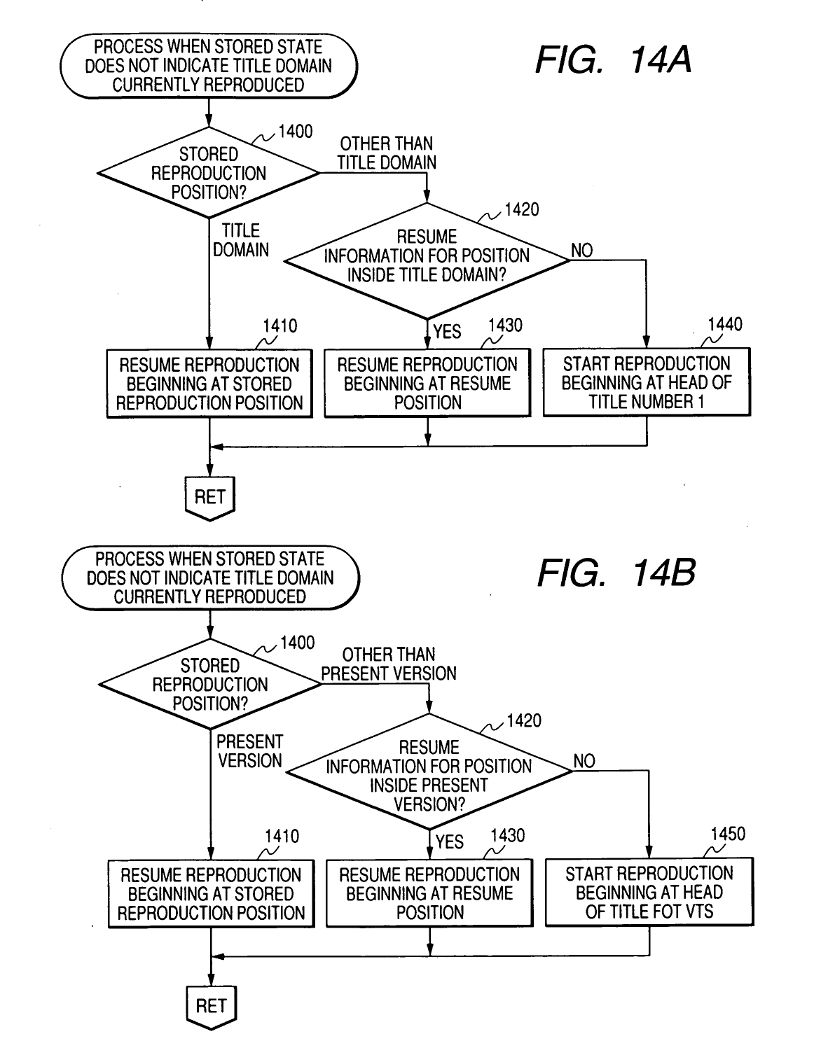

FIGS. 14A and 14B are flowcharts showing other processing performed when the state stored in the management information storage unit 230 during the changing of an audio stream does not indicate that the title domain is currently being reproduced. This processing is performed when the stored reproduction position information indicates something other than a title domain, or when the stored reproduction position information indicates a position inside a title domain but the reproduction state does not indicate reproduction is currently being performed.

As shown in the flowchart in FIG. 14A, first, the reproduced audio/video data controller 270 determines whether the reproduction position information stored in the management information storage unit 230 indicates a position inside the title domain (step S1400). When the reproduction position is inside the title domain, reproduction is forcibly resumed beginning at this position, based on the reproduction position information stored in the management information storage unit 230, regardless of whether the state stored at step S1210 is a state other than a current reproduction state, e.g., a temporary halted state (step S1410).

When the reproduction position information stored in the management information storage unit 230 indicates something other than the title domain, the reproduced audio/video data controller 270 determines whether resume information, for when the title domain has been restored, is stored in the audio/video data management information memory 250 (step S1420). When resume information is stored, reproduction is forcibly started beginning at the resume position inside the title domain (step S1430). When resume information is not stored, reproduction is forcibly started beginning at title number 1 (step S1440).

As shown in the flowchart in FIG. 14B, instead of starting reproduction beginning at title number 1 at step S1440, reproduction may be forcibly started beginning at the head title for VTS (step S1450).

As described above, according to the DVD-Video disk reproduction apparatus of the third embodiment, during the changing of an audio stream the reproduced audio/video data controller 270 performs reproduction beginning at an appropriate reproduction position, even when the state is not the title domain reproduction state. Therefore, the state extant immediately before the audio menu display indicates the reproduction of an audio stream, selected by a user, was disabled can be reestablished at the time an audio stream is selected, without a complicated user operation being required.

### Fourth Embodiment

In FIG. 15 are flowcharts showing the processing performed when an audio menu display request is issued and only one audio stream is available. This processing is performed when the audio stream count VTS_AST_Ns 720, stored in the management information storage unit 230, is only one.

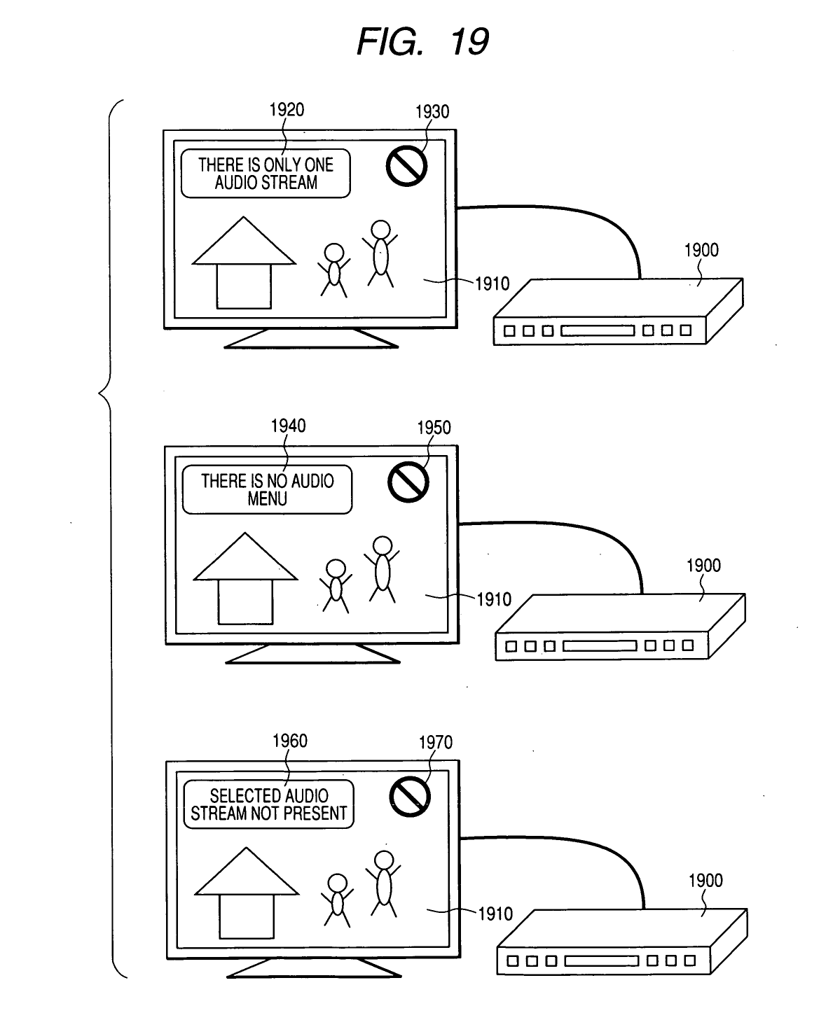

The reproduced audio/video data controller 270 notifies a user that only one audio stream is available (step S1500), and inhibits a shift to the audio menu display state. FIG. 19 is a diagram showing an example screen employed for user notification. A message is output to a monitor 1910, connected to a DVD-Video disk reproduction apparatus 1900, in order to notify a user that an audio menu display request issued by the user has been rejected. At this time, either a message 1920 indicating there is only one audio stream or simply an inhibited mark 1930 may be displayed. Further, in addition to the notification method in FIG. 19, a notification may be transmitted to an FL tube or to another output device.

As described above, according to the DVD-Video disk reproduction apparatus of the fourth embodiment, when an audio menu display request is received from the user, the reproduced audio/video data controller 270 examines the number of audio streams, and when only one audio stream is available, does not shift the state to the audio menu display. Thus, an unnecessary operation, the shifting of the state to the audio menu, can be prevented when no user selection is available.

### Fifth Embodiment

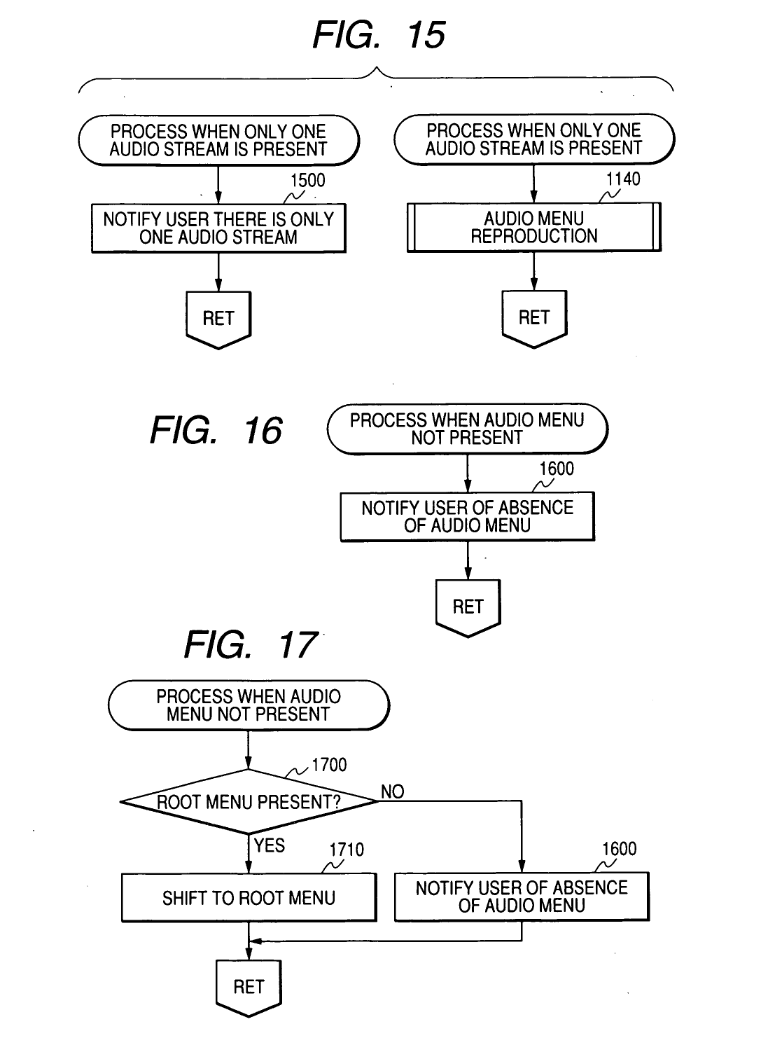

FIG. 16 is a flowchart showing the processing performed when an audio menu display request is issued and the audio menu is not present. This processing is performed when as a result of an examination of AM_EXST 520, which is stored in the management information storage unit 230, it is determined that the audio menu is not present.

The reproduced audio/video data controller 270 notifies a user that the audio menu is not present (step S1600), and inhibits a shift to the audio menu display. FIG. 19 is a diagram showing an example screen employed for user notification. A message is output to a monitor 1910, connected to a DVD-Video disk reproduction apparatus 1900, in order to notify a user that an audio menu display request issued by the user has been rejected. At this time, either a message 1940 indicating the audio menu is absent or simply an inhibited mark 1950 may be displayed. Further, in addition to the notification method shown in FIG. 19, a notification may be transmitted to an FL tube or to another output device.

As described above, according to the DVD-Video disk reproduction apparatus of the fifth embodiment, when an audio menu display request is received from a user, the reproduced audio/video data controller 270 determines the presence/absence of the audio menu, and when the audio menu is not present, notifies the user. Therefore, the user can readily ascertain that the selection of an audio stream on the audio menu has been disabled.

### Sixth Embodiment

FIG. 17 is a flowchart showing other processing performed when an audio menu display request is issued and an audio menu is not present. This processing is performed when as a result of an examination of AM_EXST 520, which is stored in the management information storage unit 230, it is determined that the audio menu is not present.

First, the reproduced audio/video data controller 270 examines ROOTM_EXST 510, which is stored in the management information storage unit 230, to determine whether the root menu is present (step S1700). When the root menu is present, it is displayed instead of the audio menu (step S1710). When neither the audio menu or the root menu are present, a message that the audio menu is not present is provided for a user (the same process as that performed at step S1600 in the flowchart in FIG. 16).

As described above, according to the DVD-Video disk reproduction apparatus of the sixth embodiment, when an audio menu display request is received from a user, the reproduced audio/video data controller 270 determines the presence/absence of the audio menu, and when the audio menu is not present, displays the root menu. Therefore, when a menu that permits the user to select an audio stream has been recorded as the root menu, the user can select an audio stream from that menu.

### Seventh Embodiment

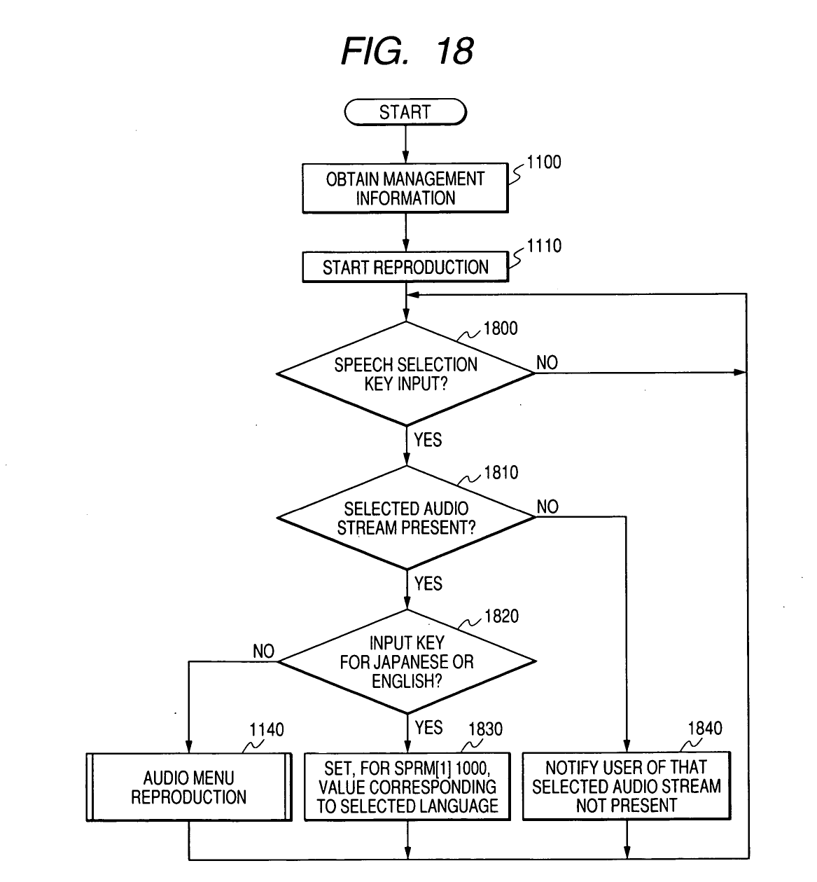

FIG. 18 is a flowchart showing the audio stream switching processing performed by a DVD-Video disk reproduction apparatus, according to a seventh embodiment of the invention, when an audio stream is designated.

When management information recorded in the audio/video format 200 is obtained (step S1100), and audio/video reproduction is started (step S1110), the reproduced audio/video data controller 270 determines whether user manipulation (e.g., the manipulation of the Japanese key 320, the English key 330 or the other audio streamselection key 340 in the speech selection area 310 of the remote controller in FIG. 2) has been employed to designate an audio stream (step S1800). When an audio stream has been so designated, the reproduced audio/video data controller 270 examines the Audio type 910 and the Specific code 920, which are stored in the management information storage unit 230, to determine whether the audio stream selected by the user is present (step S1810).

When the selected audio stream is present, the reproduced audio/video data controller 270 determines whether the input key is the Japanese key 320 or the English key 330 (step S1820). When the input key is the Japanese key 320 or the English key 330, VTS_AST_ATRT 730, which is stored in the management information storage unit 230, is examined, and an audio stream number pertinent to the selected language is obtained and stored in SPRM[1] 1000 (step S1830). When the input key is neither the Japanese key 320 nor the English key 330, the reproduced audio/video data controller 270 shifts the processing to the above described audio menu reproduction process (step S1140), and permits a user to select a predetermined audio stream.

When the audio stream selected by the user is not present, a message that the selected audio stream is not present is displayed for the user (step S1840). FIG. 19 is a diagram showing an example screen employed for user notification. A message is output to a monitor 1910, which is connected to a DVD-Video disk reproduction apparatus 1900, in order to notify a user that the audio stream switching request issued by the user has been rejected. At this time, a message 1960 indicating the absence of the selected audio stream or simply an inhibited mark 1970 may be displayed. In addition to the notification method shown in FIG. 19, a notification may be transmitted to an FL tube or to another output device.

In this embodiment, the manipulation of the Japanese key 320, the English key 330 or the audio stream selection key 340 of the remote controller has been employed as an example user manipulation employed to change an audio stream at step S1800. However, the audio stream may be changed by an entry received upon the manipulation of another specific key, following the long depression of a specified key on the remote controller, or via a user interface other than the remote controller. Furthermore, the remote controller keys that, through user operation, enable a direct audio stream change are not limited to Japanese and English keys.

As described above, according to the DVD-Video disk reproduction apparatus of the seventh embodiment, keys for designating specific audio streams, such as “Japanese” and “English”, are provided for the remote controller, and the audio stream is directly designated by the reproduced audio/video data controller 270, i.e., the switching means is constituted by the individual keys in the speech selection area and the reproduced audio/video data controller. Thus, an audio stream can be intuitively selected, and the changing of the audio stream can be performed by performing an operation requiring minimal effort. That is, a user can easily identify the target speech (language) by referring to the name of the key on the remote controller, and can easily select an audio stream, even without knowing the audio stream number corresponding to and consonant with the target language. Further, when the number recorded for the audio stream count is one, the reproduced audio/video data controller 270 provides a message to that effect for the user, so that the user can readily ascertain that selection of an audio stream has been disabled.

In the above embodiments, the speech menu key 300 provided for the remote controller has been employed as the shifting unit for shifting the state to the audio menu (step S1120 in the flowchart in FIG. 11). However, an entry received upon the use another specific key, the long depression of a specified key on the remote controller, or via a user interface other than the remote controller may be employed for the shifting of the audio menu.

In the embodiments, the operations performed to change audio streams have been explained. A DVD-Video disk reproduction apparatus having the described arrangement can also perform the same changing operation for a sub-picture stream and an angle. In this case, the state can be shifted directly to a menu display state by the manipulation of the sub-title menu key or the angle menu key in the menu screen area on the remote controller (see FIG. 2). And further, the selection of a stream can be directly performed by manipulating the individual keys in the sub-title selection area or the angle selection area.

According to the audio/video format reproduction apparatus of the present invention, and the audio/video format reproduction method and program therefor, during the reproduction of data recorded on an information recording medium, using an audio/video format that provides for a plurality of streams to be arranged for reproduction during the same period of time, individual types of streams can be intuitively selected, and the changing of streams can be easily performed by the employment of a user operation that requires minimal effort. The present invention is an effective tool for the improvement of usability.

What is claimed is:

1. An audio/video format reproduction apparatus, reproducing information recorded on an information recording medium in an audio/video format which includes a plurality of audio streams, sub-picture streams or angles which are arranged so as to be reproduced during the same period, and a selection menu that a user employs to select the audio streams, the sub-picture streams or the angles, comprising:
a reading unit, converting information included in an audio/video format into an electrical signal;
an audio/video reproduction unit, demodulating audio/video information based on information read by the reading unit;
a management information storage unit, storing management information used for reproducing audio/video information based on information read by the reading unit, and audio/video data management information used for controlling audio/video data to be reproduced;
a reproduced audio/video data controller, controlling audio/video data to be reproduced;
an input unit, transmitting entries by a user; and
a shifting unit, directly shifting an arbitrary state to a selection menu display state.

2. The audio/video format reproduction apparatus according to claim 1, wherein, before shifting to the selection menu display state, the shifting unit stores information for a preceding reproduction position and a preceding reproduction state.

3. The audio/video format reproduction apparatus according to claim 2, wherein, when a navigation command to be executed is determined in the selection menu display state, the shifting unit inhibits the execution of other navigation commands, such as one entered using a button on the selection menu, the execution of which is likely to have been determined based on the assumption that the selection menu is displayed through a normal root.

4. The audio/video format reproduction apparatus according to claim 2, wherein, when a user selects an audio stream, a sub-picture stream or an angle in the selection menu display state, the shifting unit employs the reproduction position information and the reproduction state and begins to reproduce the selected audio stream, sub-picture stream or angle at a previously stored reproduction position.

5. The audio/video format reproduction apparatus according to claim 4, wherein, when the condition of an audio stream, a sub-picture stream or an angle selected by a user is one for which reproduction is not enabled, the shifting unit waits until reproduction is enabled before beginning to reproduce the audio stream, the sub-picture stream or the angle that is selected.

6. The audio/video format reproduction apparatus according to claim 4, wherein, when the condition at the time an audio stream, a sub-picture stream or an angle is selected by a user is not one whereunder reproduction is enabled, the shifting unit forcibly shifts the audio stream, the sub-picture stream or the angle that is selected to a reproduction enabled state and starts reproduction.

7. The audio/video format reproduction apparatus according to claim 1, wherein, when only one audio stream, one sub-picture stream or one angle is available when the state is shifted to the selection menu display state, the shifting unit provides a notification to that effect for a user and does not display the selection menu.

8. The audio/video format reproduction apparatus according to claim 1, wherein, when a selection menu is not included in management information for shifting to the selection menu display state, the shifting unit provides a notification to that effect for a user.

9. The audio/video format reproduction apparatus according to claim 1, wherein, when a selection menu is not included in management information for shifting to the selection menu display state, the shifting unit shifts instead to a root menu display state.

10. An audio/video format reproduction apparatus, which reproduces information recorded on an information recording medium in an audio/video format that includes a plurality of audio streams, sub-picture streams or angles arranged so as to be reproduced during the same period, comprising:
a reading unit, converting information included in an audio/video format into an electrical signal;
an audio/video reproduction unit, demodulating audio/video information based on information read by the reading unit;
a management information storage unit, storing management information used for reproducing audio/video information based on information read by the reading unit, and audio/video data management information, used for controlling audio/video data to be reproduced;
a reproduced audio/video data controller, controlling audio/video data to be reproduced;
an input unit, transmitting an entry by a user; and
a switching unit, changing, in an arbitrary state, to another audio stream, another sub-picture stream or another angle.

11. The audio/video format reproduction apparatus according to claim 10, wherein, when there is only one audio stream, one sub-picture stream or one angle to be changed, the switching unit provides a notification to that effect for a user and does not change audio streams, sub-picture streams or angles.

12. An audio/video format reproduction method, for reproducing information recorded on an information recording medium in an audio/video format that includes a plurality of audio streams, sub-picture streams or angles, arranged for reproducing during the same period, and a selection menu that a user employs to select the audio streams, the sub-picture streams or the angles, comprising:
a shifting step of directly shifting an arbitrary state to a selection menu display state.

13. The audio/video format reproduction method according to claim 12, whereby, before shifting to the selection menu display state, information for a preceding reproduction position and a preceding reproduction state is stored at the shifting step.

14. The audio/video format reproduction method according to claim 12, whereby, when a navigation command to be executed is determined in the selection menu display state, the execution of other navigation commands, such as one entered using a button on the selection menu, the execution of which is likely to have been determined based on the assumption that the selection menu is displayed through a normal root, is inhibited at the shifting step.

15. The audio/video format reproduction method according to claim 13, whereby, when a user selects an audio stream, a sub-picture stream or an angle in the selection menu display state, at the shifting step, reproduction of the audio stream, the sub-picture stream or the angle that is selected is started at a previously stored reproduction position based on the reproduction position information and the reproduction state.

16. The audio/video format reproduction method according to claim 15, whereby, when the condition of an audio stream, a sub-picture stream or an angle selected by a user is one for which reproduction is not enabled, at the shifting step, starting to reproduce the audio stream, the sub-picture stream or the angle that is selected is waited until reproduction is enabled.

17. The audio/video format reproduction method according to claim 15, whereby, when the condition at the time an audio stream, a sub-picture stream or an angle is selected by a user is not one whereunder reproduction is enabled, at the shifting step, the audio stream, the sub-picture stream or the angle that is selected is forcibly shifted to a reproduction enabled state and starts reproduction.

18. The audio/video format reproduction method according to claim 12, whereby, when only one audio stream, one sub-picture stream or one angle is available when the state is shifted to the selection menu display state, at the shifting step, a notification to that effect is provided for a user and does not display the selection menu.

19. The audio/video format reproduction method according to claim 12, whereby, when a selection menu is not included in management information for shifting to the selection menu display state, at the shifting step, a notification to that effect is provided for a user.

20. The audio/video format reproduction method according to claim 12, whereby, when a selection menu is not included in management information for shifting to the selection menu display state, at the shifting step, shifting instead to a root menu display state is performed.

21. An audio/video format reproduction method, for reproducing information recorded on an information recording medium in an audio/video format that includes a plurality of audio streams, sub-picture streams or angles arranged so as to be reproduced during the same period, comprising:
a switching step of changing, in an arbitrary state, to another audio stream, another sub-picture stream or another angle.

22. The audio/video format reproduction method according to claim 21, whereby, when there is only one audio stream, one sub-picture stream or one angle to be changed, at the switching step, a notification to that effect is provided for a user and does not change audio streams, sub-picture streams or angles.

23. A program, which permits a computer to perform the individual operations of an audio/video format reproduction apparatus that reproduces information, recorded on an information recording medium, having an audio/video format that includes a plurality of audio streams, sub-picture streams or angles, arranged for reproduction during the same period of time, and a selection menu a user employs to select audio streams, sub-picture streams or angles, and which permits the computer to perform:
a shifting step of directly shifting an arbitrary state to a selection menu display state.

24. The program according to claim 23, whereby, before shifting to the selection menu display state, information for a preceding reproduction position and a preceding reproduction state is stored at the shifting step.

25. The program according to claim 24, whereby, when a navigation command to be executed is determined in the selection menu display state, the execution of other navigation commands, such as one entered using a button on the selection menu, the execution of which is likely to have been determined based on the assumption that the selection menu is displayed through a normal root, is inhibited at the shifting step.

26. The program according to claim 24, whereby, when a user selects an audio stream, a sub-picture stream or an angle in the selection menu display state, at the shifting step, reproduction of the audio stream, the sub-picture stream or the angle that is selected is started at a previously stored reproduction position based on the reproduction position information and the reproduction state.

27. The program according to claim 26, whereby, when the condition of an audio stream, a sub-picture stream or an angle selected by a user is one for which reproduction is not enabled, at the shifting step, starting to reproduce the audio stream, the sub-picture stream or the angle that is selected is waited until reproduction is enabled.

28. The program according to claim 26, whereby, when the condition at the time an audio stream, a sub-picture stream or an angle is selected by a user is not one whereunder reproduction is enabled, at the shifting step, the audio stream, the sub-picture stream or the angle that is selected is forcibly shifted to a reproduction enabled state and starts reproduction.

29. The program according to claim 23, whereby, when only one audio stream, one sub-picture stream or one angle is available when the state is shifted to the selection menu display state, at the shifting step, a notification to that effect is provided for a user and does not display the selection menu.

30. The program according to claim 23, whereby, when a selection menu is not included in management information for shifting to the selection menu display state, at the shifting step, a notification to that effect is provided for a user.

31. The program according to claim 23, whereby, when a selection menu is not included in management information for shifting to the selection menu display state, at the shifting step, shifting instead to a root menu display state is performed.

32. A program, which permits a computer to perform the individual operations of an audio/video format reproduction apparatus that reproduces information recorded, on an information recording medium, using an audio/video format that includes a plurality of audio streams, sub-picture streams or angles arranged for reproduction during the same period of time, and which permits the computer to perform:
a switching step of changing, in an arbitrary state, to another audio stream, another sub-picture stream or another angle.

33. The program according to claim 32, whereby, when there is only one audio stream, one sub-picture stream or one angle to be changed, at the switching step, a notification to that effect is provided for a user and does not change audio streams, sub-picture streams or one angles.

34. The audio/video format reproduction apparatus according to 1, wherein the audio/video format conforms to the DVD-Video standards.

35. The audio/video format reproduction apparatus according to 10, wherein the audio/video format conforms to the DVD-Video standards.

36. The audio/video format reproduction method according to claim 12, whereby the audio/video format conforms to the DVD-Video standards.

37. The audio/video format reproduction method according to claim 21, whereby the audio/video format conforms to the DVD-Video standards.

38. The program according to claim 23, whereby the audio/video format conforms to the DVD-Video standards.

39. The program according to claim 32, whereby the audio/video format conforms to the DVD-Video standards.

40. The computer-readable recording medium, according to claim 23, on which a program is recorded.

41. The computer-readable recording medium, according to claim 32, on which a program is recorded.
